(19) United States
(12) Patent Application Publication
(10) Pub. No.: US 2003/0079233 A1
(43) Pub. Date: Apr. 24, 2003

(54) Method for consolidation of services, equipment, and content using spectrally efficient transport

(76) Inventors: Paul J. Matthews, Ellicott City, MD (US); Paul D. Biernacki, Fairfax, VA (US); Irl N. Duling, Lancaster, PA (US)

Correspondence Address: PILLSBURY WINTHROP, LLP, P.O. BOX 10500, MCLEAN, VA, 22102, US

(21) Appl. No.: 10/266,930

(22) Filed: Oct. 9, 2002

Related U.S. Application Data
(60) Provisional application No. 60/327,778, filed on Oct. 10, 2001.

(51) Int. Cl. H04N 7/173; H04N 7/16

(52) U.S. Cl. 725/129; 725/117; 725/147; 725/118

(57) ABSTRACT

An arrangement is provided for consolidating equipment, services, and information and for distributing information from a consolidated information distribution center (CIDC) to a plurality of head ends using spectrally efficient transport. The CIDC generates an optical signal encoded with information of multiple channels aggregated through a multi-level encoding scheme and sends the optical signal to a plurality of head ends via an optical fiber. When a head end receives the optical signal, it decodes the optical signal in multiple stages to produce information of multiple data streams, from which desired data streams are selected.

This Application is based on Provisional Application No. 60/327,778 filed Oct. 10, 2001, the entire contents of which is hereby incorporated by reference.

### BACKGROUND

1. Field of Invention

The present invention relates to information distribution architecture and arrangements for transporting information from a central location via an optical fiber.

2. Discussion of Related Art

Currently, many industries such as cable television (CATV), use proprietary hybrid fiber-coax (HFC) architectures to service a given metropolitan area. As technology is evolving, the trend in system design is to consolidate services, equipment, and information, further upstream, to effect savings in space, cost, and maintenance. Previous implementations have most of the information and equipment concentrated at hub sites due to difficulties in distributing the information. In contrast, most current architectures consolidate equipment and information sources (e.g., satellites, video servers, IP routers, or reception antennas) at so called “head end”, “master end”, or “regional head end”, that are upstream of hubs. Such architectures allowed the aggregation of resources which subsequently resulted in better efficiency, increased service offerings, and increased revenues for the CATV industry.

Further aggregation of services and information beyond a given metropolitan region is inherently advantageous in light of the continuing demand for information and subsequent capital equipment costs for real-time services such as video on demand. The technological evolution in this direction, however, has been hindered for a variety of reasons, including lack of available bandwidth, lack of efficient means for long-haul transport which is amenable to the types of signals and information typically used by CATV providers, as well as regulatory obstacles that have prevented contiguous metropolitan regions from being served by a single CATV provider.

Different solutions have been proposed to link regional head ends in order to implement aggregated services and take advantage of the resulted cost effectiveness and efficiency of information aggregation. There have been various attempts to stream video information over IP-based transport. However, the underlying technologies of these solutions are not fundamentally compatible with the information and delivery of services required for CATV.

### SUMMARY

In accordance with the present invention, a method is provided for distributing large bandwidth continuous data streams from a centralized location. The centralized location may correspond to a consolidated information distribution center that consolidates various equipment, information from a plurality of sources, and services and distributes such consolidated information to a plurality of head ends via an optical transmission fiber. The information may constitute multiple data streams. When the information is distributed to the head ends, it is encoded and transported in a spectrally efficient manner.

In a preferred embodiment, a first consolidated information distribution center and the head ends are arranged in an linear configuration in which information is broadcasted to all head ends via a single optical fiber and is transported downstream to the head ends in a serial fashion. Each head end receives the encoded information, decodes it to generate multiple data streams, and selects desired information from the multiple data streams.

In a different preferred embodiment, the first consolidated information distribution center and the head ends are arranged in a star configuration in which information is broadcasted to all head ends via a plurality of optical fibers and is transported downstream to the head ends in a parallel fashion. Each head end receives the encoded information, decodes it to generate multiple data streams, and selects desired information from the multiple data streams.

In another different preferred embodiment, the first consolidated information distribution center and the head ends are arranged in a ring configuration in which head ends are connected via a single optical fiber and arranged in a circular fashion. The first consolidated information distribution center broadcasts information to the head ends via the optical fiber in both clockwise and counter clock directions. Each head end receives the encoded information, decodes it to generate multiple data streams, and selects desired information from the multiple data streams.

In other different preferred embodiments, a second consolidated information distribution center is introduced in any one of the above described configurations for fault tolerance. The second consolidated information distribution center may operate synchronously with the first consolidated information distribution center. Both consolidated information distribution centers may acquire the same information, encode the information in a same fashion, and transmits the encoded information at the same time. In a serial configuration, both consolidated information distribution centers send encoded information downstream to the head ends via a same optical fiber but in opposite directions. In a star configuration, both consolidated information distribution centers send encoded information downstream to the head ends via a same set of optical fibers but in opposite directions.

In accordance with another aspect of the invention, a consolidated information distribution center encodes information in a spectrally efficient manner. An encoding scheme is adopted, in which multi-level encoding is coupled with sub-carrier multiplexing, optical modulation, and wavelength division multiplexing. At the stage of multi-level encoding, multiple data streams are modulated using, for example, quadrature amplitude modulation scheme. Such modulated signals are then multiplexed onto different sub-carriers or RF/microwave carriers. Information is further aggregated at this stage. Optical modulation up-converts aggregated RF signals onto corresponding optical carriers which are then further multiplexed through wavelength division multiplexing to generate an optical signal to be transmitted through an optical fiber to the head ends.

In accordance with yet another aspect of the invention, each of the head ends receiving an optical signal over an optical transmission fiber decodes the optical signal in a reversed process. The received optical signal is demultiplexed to generate a plurality of optical channels. Each of the optical signals in such optical channels is down-converted into corresponding RF carriers that carry RF signals, which is further demodulated to generate information with multiple data streams. To obtain desired information, each head end selects, among multiple data streams, the desired information. In a configuration where a second consolidated information distribution center is present, each head end is further capable of switching to receive the optical signal from one of the consolidated information distribution centers.

### BRIEF DESCRIPTION OF THE DRAWINGS

The inventions claimed and/or described herein are further described in terms of exemplary embodiments. These exemplary embodiments are described in detail with reference to the drawings. These embodiments are non limiting exemplary embodiments, in which like reference numerals represent similar parts throughout the several views of the drawings, and wherein:

FIG. 1 depicts an exemplary consolidated content delivery framework, according to a first embodiment of the present invention;

FIG. 2 depicts an exemplary consolidated content delivery framework, according to a second embodiment of the present invention;

FIG. 3 depicts an exemplary consolidated content delivery framework, according to a third embodiment of the present invention;

FIG. 4 depicts an exemplary consolidated content delivery framework, according to a fourth embodiment of the present invention;

FIG. 5 is an exemplary block diagram of a consolidated information distribution center, according to embodiments of the present invention;

FIG. 6 is an exemplary block diagram of an optical signal generation mechanism, according to embodiments of the present invention;

FIG. 7 is an exemplary block diagram of a quadrature amplitude modulation mechanism;

FIG. 8 is an exemplary block diagram of a frequency division multiplexer;

FIG. 9 shows an exemplary distribution of optical amplifiers along an optical fiber, according to an embodiment of the present invention;

FIG. 10 depicts an exemplary block diagram of a head end, according to embodiments of the present invention;

FIG. 11 is a flowchart of an exemplary process, in which a consolidated content delivery framework sends an optical signal carrying content data of multiple channels to a plurality of head ends via an optical fiber, according to embodiments of the present invention;

FIG. 12 is a flowchart of an exemplary process, in which a consolidated information distribution center encodes content data of multiple channels to generate an optical signal, according to embodiments of the present invention; and

FIG. 13 is a flowchart of an exemplary process, in which a head end receives an optical signal from a consolidated information distribution center via an optical fiber and decodes the optical signal to generate content data of multiple channels, according to embodiments of the present invention.

### DETAILED DESCRIPTION

The present invention involves a consolidated information distribution system, wherein a consolidated information distribution center consolidates resources and effectively distributes information, via an optical fiber, to a plurality of head ends. The consolidated resources include information from a plurality of sources, the equipment that are necessary to acquire the information from different sources, the equipment to efficiently encode the information, and the devices to transmit the encoded information. By consolidating the resources conventionally distributed in every head end, the cost associated with information distribution is reduced. When head ends cross regional boundaries, this information distribution scheme also enables consolidated services.

Associated with this consolidated information distribution system is an efficient encoding scheme that allows information with multiple data streams to be aggregated at multiple stages so that large bandwidth continuous information streams can be multiplexed into an optical signal and transported through an optical transmission fiber.

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software or firmware being run by a general-purpose or network processor. Data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, computer-readable media may comprise any form of data storage mechanism, including such existing memory technologies as well as hardware or circuit representations of such structures and of such data.

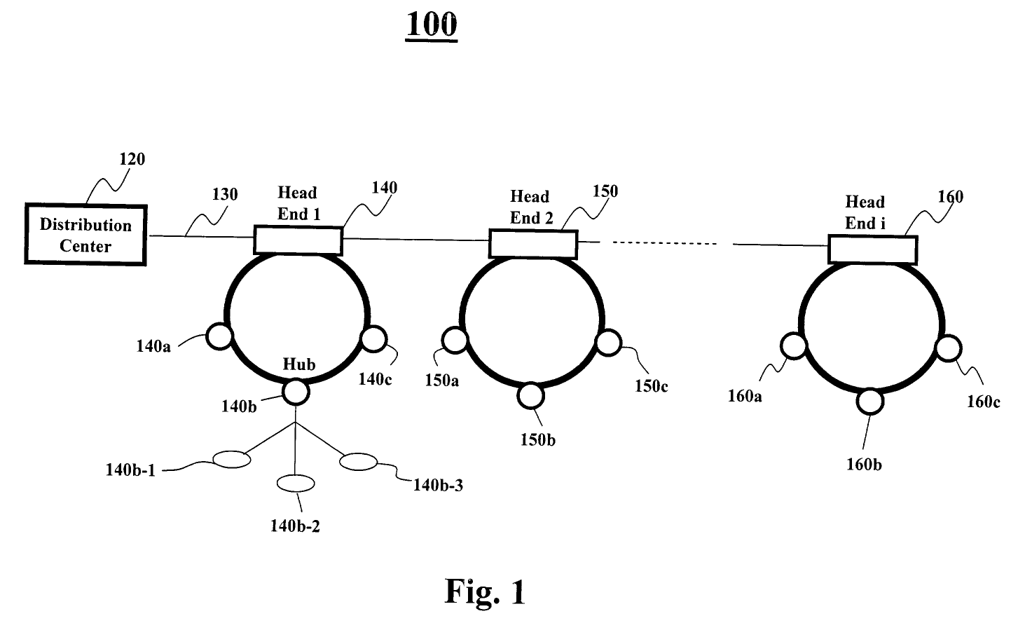

FIG. 1 depicts an exemplary consolidated content delivery framework 100, according to a first embodiment of the present invention. The framework 100 comprises a consolidated information distribution center (CIDC) 120, a plurality of head ends (head end 1 140, head end 2 150, . . . , and head end i 160), and an optical fiber 130 that connects the CIDC 120 and the head ends 140, 150, . . . , 160. The head ends 140, 150, . . . , 160 are connected via the optical fiber 130 in a serial fashion. The CIDC 120 sends content data, encoded as an optical signal, via the optical fiber 130 to the head ends. The optical signal may be a single optical signal that has a plurality of wavelength channels in a wavelength division multiplexed transmission line. It may also include strings of information that have been sub-carrier multiplexed. These possible embodiments will be described in more detail below. The optical signal from the CIDC 120 travels along in the direction from the first head end to the last head end. That is, the optical signal reaches the head end 1 140 first, the head end 2 150 second, . . . , and the head end i 160 the last.

Each of the head ends may be a master head end or a regional head end and may include a plurality of hubs. For example, the head end 1 140 includes hubs 140a, 140b, . . . , 140c; the head end 2 150 includes hubs 150a, 150b, . . . , 150c; and the head end i 160 includes hubs 160a, 160b, . . . , 160c. Each head end distributes content data to its own hubs. Each hub under a head end may further include a plurality of nodes. For example, the hub 140b includes three nodes 140b-1, 140b-2, and 140b-3. Each of such nodes may be responsible for distributing content data to a plurality of sites (not shown) which may correspond to residential homes. Different head ends may distribute different contents to their hubs. In addition, each hub may distribute different content to its nodes, and each node may distribute different content to the sites that it is responsible for.

The CIDC 120 consolidates equipment that are necessary for variety of purposes. Content may be acquired from different sources via some network, which may include a proprietary network, a cable network, a satellite network, a wireless network, or the Internet. Different equipment may be required to receive content data from different networks. For example, to receive content from a satellite, one or more satellite dishes may be required. In addition, content may be generated at the CIDC 120. Storage units may be needed to store content and servers may become necessary to manage such storage units. Furthermore, to distribute content to the head ends 140, 150, . . . , 160 via the optical fiber 130, the CIDC 120 also includes equipment capable of encoding content data to generate an optical signal.

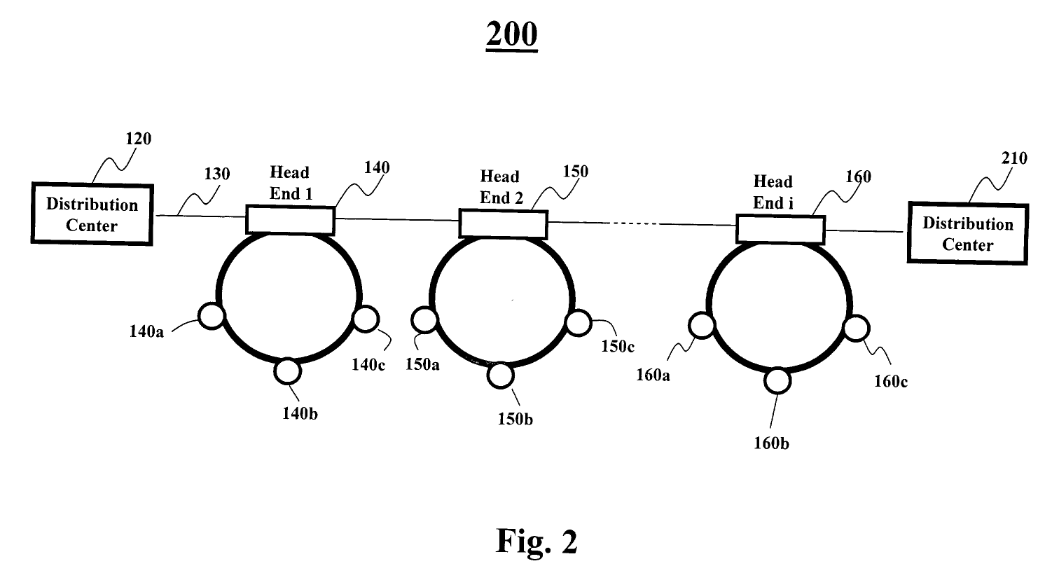

FIG. 2 depicts an exemplary consolidated content delivery framework 200, according to a second embodiment of the present invention. To provide fault tolerance to the framework 100, the framework 200 includes a second CIDC 210, connecting to the linearly arranged head ends 140, 150, . . . , 160 from the opposite end. That is, the CIDC 210 is located closest to the last head end with respect to the CIDC 120. In the depicted embodiment shown in FIG. 2, the CIDC 210 is connected to the end closest to the head end 160.

The CIDC 210 may possess the same capability as the CIDC 120. It may synchronize with the CIDC 120, distributing the same content to the head ends 140, 150, . . . , 160 at the same time. However, the CIDC 210 may acquire, store, and manipulate content independently. For example, the CIDC 210 may have its own satellite dishes, its own storage systems, its own video servers, as well as its own content encoding mechanism. In addition, the CIDC 210 may generate an optical signal based on its own version of the content data (e.g., same content as what the CIDC 120 has) and send its optical signal to the head ends. Furthermore, when the optical signal from the CIDC 210 is sent to the head ends, the optical signal may be sent in an opposite direction as the signal from the CIDC 120. That is, the optical signal from the CIDC 210 travels along the optical fiber 130 in a direction from the head end 160 to the head end 150 and finally to the head end 140.

The framework 200 provides fault tolerance through the CIDC 210. With both the CIDC 120 and the CIDC 210 synchronously distributing the same content data to the head ends, when one of the CIDCs fails to function, the head ends may still receive the encoded content data. This requires that each of the head ends have the capability of receiving content data from both CIDCs and at a certain time determine which optical signal to intercept.

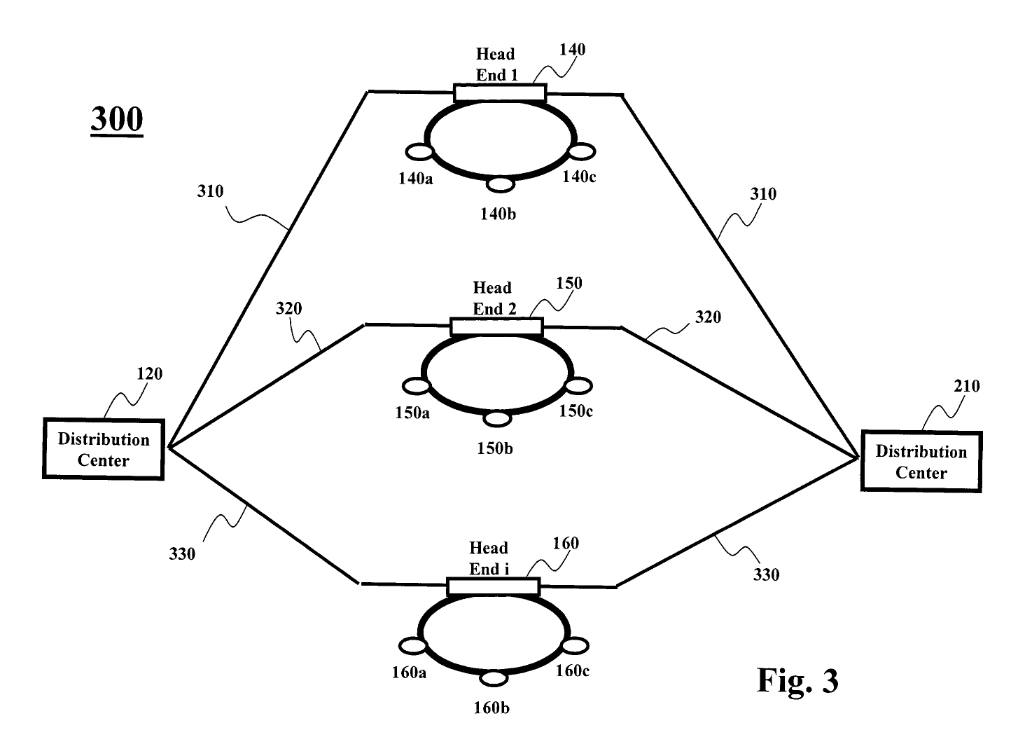

FIG. 3 depicts an exemplary consolidated content delivery framework 300, according to a third embodiment of the present invention. The framework 300 represents an alternative configuration, in which the head ends 140, 150, . . . , 160 are arranged, with respect to the CIDC 120, in a star configuration. Every head end is directly connected to the CIDC 120 via an optical fiber: the head end 1 140 through an optical fiber 310, the head end 2 150 through an optical fiber 320, . . . , the head end i 160 through an optical fiber 330. With this configuration, an optical signal encoding the content data from the CIDC 120 is broadcast to all the head ends through the optical fibers 310, 320, . . . , 330.

Alternatively, the framework 300 may also include a second CIDC 210 to provide fault tolerance. The CIDC 210 connects to the head ends via the optical fibers 310, 320, . . . , 330 and sends its optical signal to the head ends in an opposite direction.

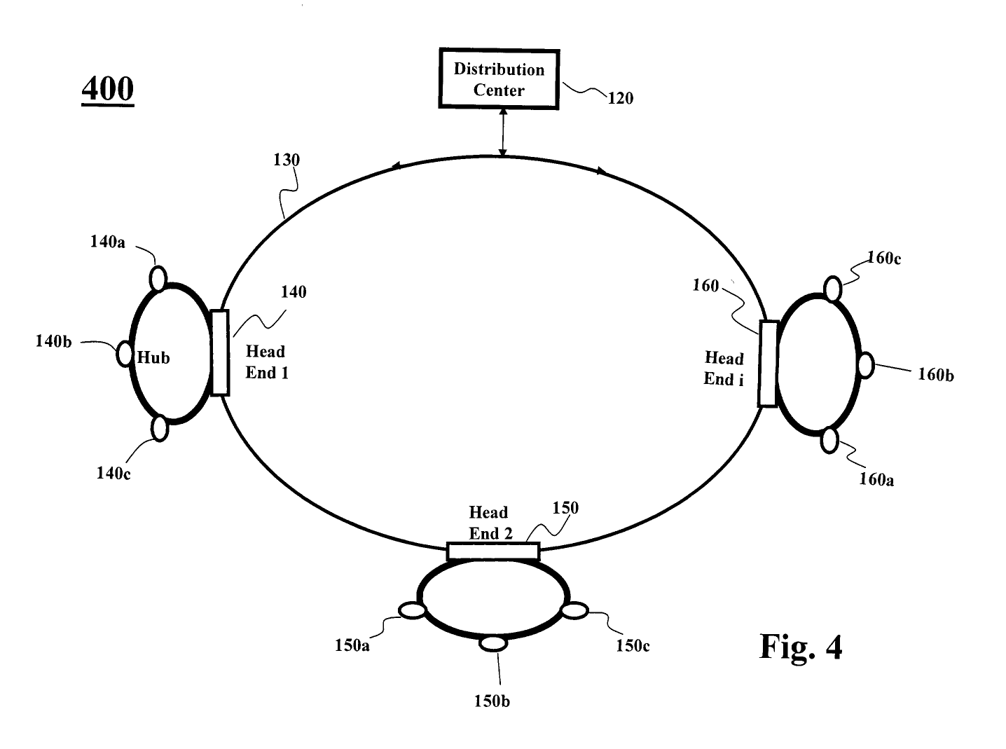

FIG. 4 depicts an exemplary consolidated content delivery framework 400, according to a fourth embodiment of the present invention. The framework 400 represents yet another alternative configuration, in which the head ends 140, 150, . . . , 160 are arranged, with respect to the CIDC 120, in a ring configuration. The head ends 140, 150, . . . , 160 are arranged in a circular fashion and are connected via the optical fiber 130. The CIDC 120 sends an optical signal to the head ends via the optical fiber and the optical signal may be sent along both a clockwise direction and a counterclockwise direction. Alternatively, the framework 400 may also include a second CIDC (not shown) to provide fault tolerance.

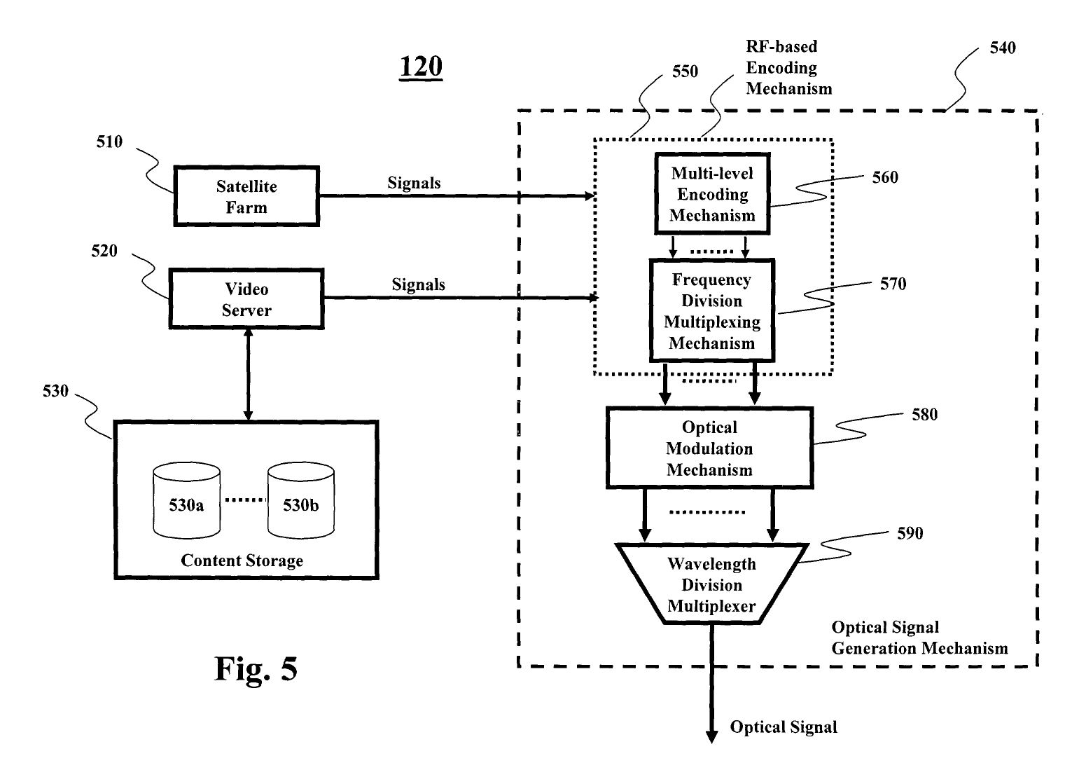

FIG. 5 is an exemplary block diagram of a consolidated information distribution center (e.g., the CIDC 120), according to embodiments of the present invention. The CIDC 120 may comprise, but is not limited to, a satellite farm 510, a video server 520, a content storage unit 530, and an optical signal generation mechanism 540. The satellite farm 510 may include a plurality of satellite dishes (not shown) that intercept signals from satellites. The video server 520 may comprise one or more physical servers that may facilitate different needs in content distribution. For instance, the video server 520 may facilitate video on demand (VoD) to provide digital video content based on what a subscriber/user requests through a head end. The video server 520 may also manage the content storage unit 530.

The content storage unit 530 is used to store content which may be, for example, digital video encoded in MPEG2. The content storage unit 530 may include a plurality of storage devices 530a, . . . , 530b that may be managed by the video server 520. The content stored in the content storage unit 530 may be retrieved dynamically and such content may be broadcasted or sent to the head ends 140, 150, . . . , 160 based on demand. The content from either the satellite farm 5 10 or the video server 520 may constitute multiple channels and each channel may comprises one or more data streams. For instance, the content intercepted from satellites by the satellite farm 510 may constitute TV broadcast of many channels and content of each channel may further comprise separate data streams such as video, audio, and transcriptions. The content stored in the content storage unit 530 may be organized as such or in other fashions to facilitate efficient data storage and access.

The optical signal generation mechanism 540 takes signals from either the satellite farm 510 or the video server 520 or both (representing the content to be distributed) and generates a single optical signal as its output to be sent to the head ends 140, 150, . . . , 160 via an optical fiber (FIGS. 1, 2, 3, and 4). The optical signal generation mechanism 540 may generate the optical signal in more than one stage. For instance, input signals may be first modulated in a spectrally efficient manner. Such modulated signals may then be multiplexed onto radio frequency (RF)/microwave sub-carriers. To transmit such encoded content through an optical fiber (e.g., the optical fiber 130), the RF sub-carriers may be further up-converted onto optical carriers, each may be at a different wavelength, and then multiplexed to yield a single wavelength division multiplexed optical signal.

Corresponding to the above-described stages, the optical signal generation mechanism 540 comprises an RF-based encoding mechanism 550, an optical modulation mechanism 580, and a wavelength division multiplexer (WDM) 590. The RF-based encoding mechanism 550 modulates the content into one or more RF/microwave carriers. The RF-based encoding mechanism 550 includes a multi-level encoding mechanism 560 and a frequency division multiplexing (FDM) mechanism 570. The multi-level encoding mechanism 560 may modulate signals corresponding to content of different data streams to yield modulated signals. Modulated signals may be combined through the FDM mechanism 570 that multiplexes modulated signals of different data streams onto a single RF/microwave carrier of a particular frequency, yielding a single RF signal.

One or more different RF/microwave carriers of different frequencies may be used to carry modulated signals. When only one RF carrier is used, different groups of data streams may be multiplexed onto the same RF carrier of a fixed frequency, yielding different RF signals. When multiple RF carriers are used, different groups of data streams may be multiplexed onto corresponding multiple RF carriers of different frequencies. Such generated RF signals carry data streams based on different frequencies.

Each of the RF signals, either carried by RF carriers of the same frequency or different frequencies, can be up-converted onto different optical carriers of different wavelengths. This is achieved through the optical modulation mechanism 580. Specifically, the optical modulation mechanism 580 may include a plurality of optical modulators, each of which up-converts a single RF signal onto a corresponding optical carrier of a particular wavelength. Since an RF carrier may carry more than one data stream, these data streams may then be aggregated onto a single optical carrier. The number of data streams that can be aggregated onto a single optical carrier may be computed through dividing the total bandwidth of the optical carrier by the bandwidth required by each data stream, where the bandwidth required by each data stream may depend on the modulation scheme used.

The optical modulation mechanism 580 generates a plurality of optical signals, each carried by a single optical carrier. The multiple data streams can be further aggregated to generate a single optical signal. This is achieved by the wavelength division multiplexer (WDM) 590, which takes a plurality of optical signals, carrying the multiple data streams, and multiplexes the optical signals to generate a single optical signal as the output of the CIDC 120 having a plurality of WDM channels.

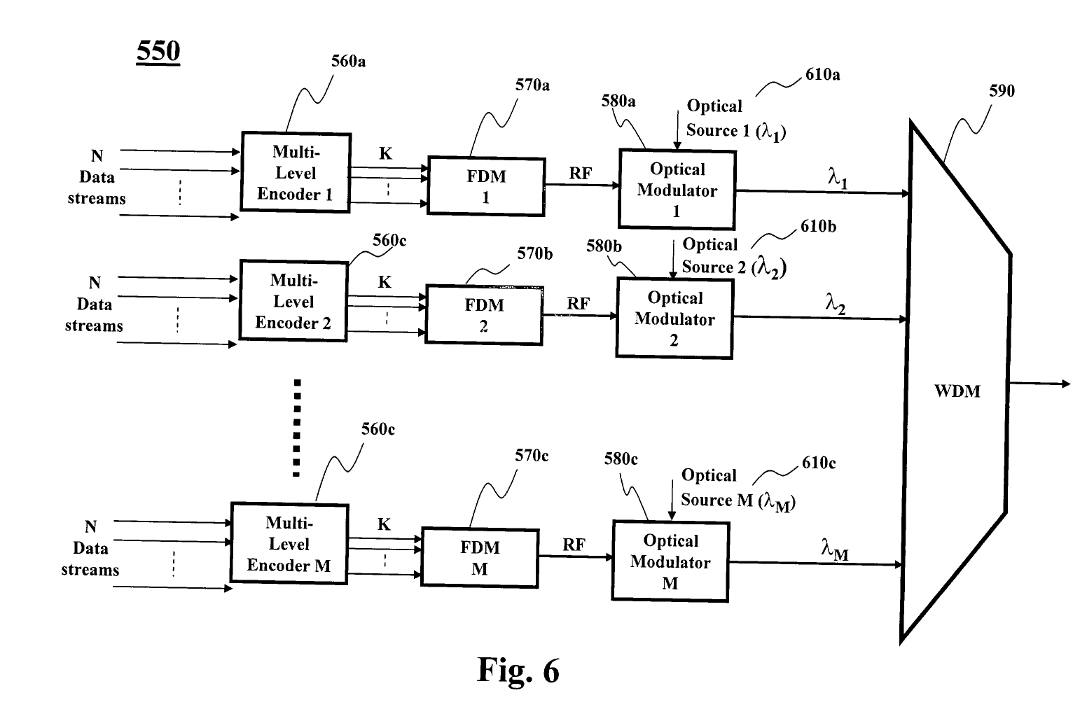

FIG. 6 is a detailed exemplary block diagram of the optical signal generation mechanism 540, according to embodiments of the present invention. The RF-based encoding mechanism 550 may include M multi-level encoders (multi-level encoder 1 560a, multi-level encoder 2 560b, . . . , multi-level encoder m 560c) in the multi-level encoding mechanism 560 and M frequency division multiplexers (FDMs) (FDM 1 570a, FDM 2 570b, . . . , FDM m 570c) in the FDM mechanism 570. Correspondingly, the optical modulation mechanism 580 also includes M optimal modulators (optical modulator 1 580a, optical modulator 2 580b, . . . , optical modulator M 580c).

Each of the optical modulators takes an RF signal and up-converts the RF signal onto an optical carrier determined by an optical source with a different wavelength. An optical source 1 610a with wavelength λ₁ is used by the optical modulator 1 580a to convert an RF signal onto an optical carrier with wavelength λ₁. Similarly, an optical source 1 610a with wavelength λ₂ is used by the optical modulator 2 580b to convert an RF signal onto an optical carrier with wavelength λ₂, etc.

The content data comprising multiple data streams may be divided into M groups, each of which includes N data streams. The first group of N data streams is processed by the multi-level encoder 1 560a, the FDM 1 570a, and the optimal modulator 1 580a. The multi-level encoder 1 560a modulates the N data streams and generates K modulated signals. Here, K is not necessarily equal to N. That is, the multi-level encoder 1 560a may combine more than one data streams into a single modulated signal. The output of the pipeline for the first group of data streams produces an optical signal carried on an optical carrier with wavelength λ₁. Similarly, the second group of N data streams is processed by the multi-level encoder 560b, the FDM 2 570b, and the optical modulator 2 580b and the pipeline produces an optical signal carried by an optical carrier of wavelength λ₂, etc. The optical signals with wavelengths λ₁, λ₂, . . . , λ_{M} are then multiplexed by the WDM 590 to produce a single optical signal.

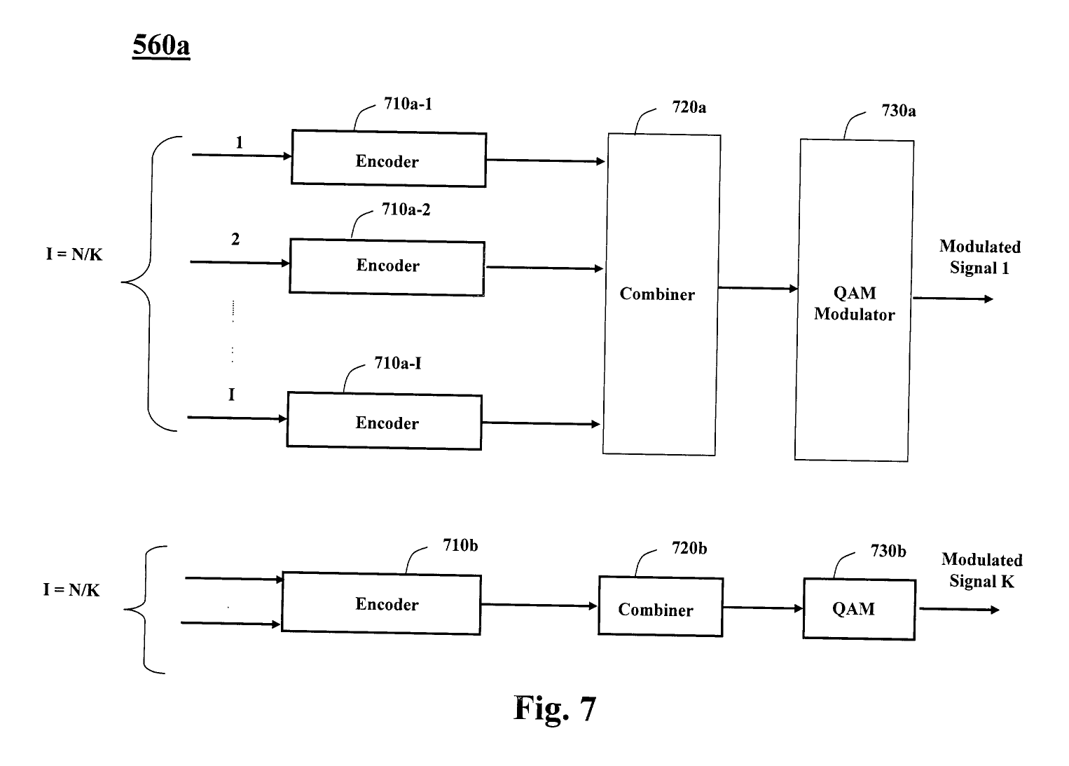

FIG. 7 is an exemplary block diagram of a multi-level encoder (e.g., 560a) implemented in a quadrature amplitude modulation (QAM) scheme. In the illustrated diagram, N data streams are divided into K groups, each of which has I=N/K data streams that are to be modulated into a single modulated signal. For each group, there are I encoders (e.g., encoder 710a-1, 710a-2, . . . , 710a-I) to encode the I data streams. A combiner (e.g., 720a) combines these I encoded data streams into a single data stream which is then modulated by an QAM modulator 730a to generate a single modulated signal (e.g., modulated signal 1). When N=K, I is one. In this case, there is no data aggregation. Other groups of I data streams are similarly modulated.

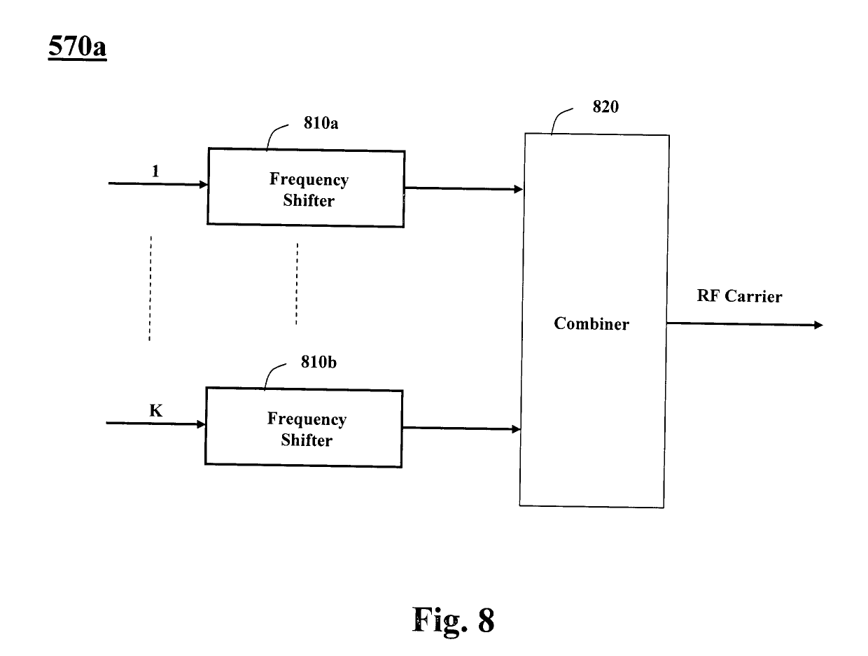

FIG. 8 is an exemplary block diagram of a FDM (e.g., 570a). Each FDM takes K modulated signals as input (see FIGS. 6 and 7) and generates a single RF signal carried on an RF/microwave carrier with a particular frequency. The FDM 570a may comprise K frequency shifters (frequency shifter 1 810a, . . . , frequency shifter K 810b) and a combiner. Each of the frequency shifters takes a modulated signal and shifts it to a certain frequency by, for example, mixing the modulated signal with an oscillator tuned to the desired frequency. The K shifters shift each modulated signal to a different frequency and all the shifted frequencies are different from the frequencies used by the RF/microwave carriers. The shifted signals are combined in the combiner 820 that produces a single RF signal that is carried by an RF/microwave carrier. In this case, the resulted RF signal has K different tones, each of which corresponds to a different modulated signal.

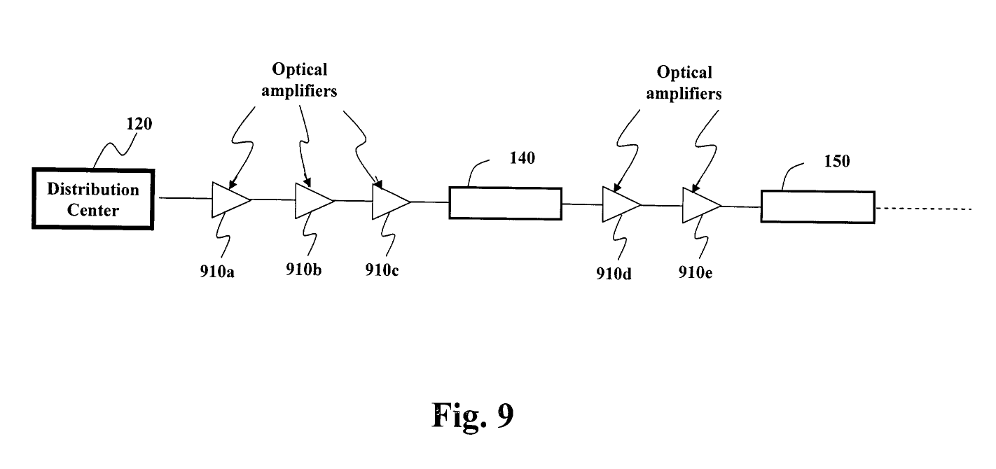

FIG. 9 shows a scheme in which one or more optical amplifiers are distributed along the optical fiber 130, according to an embodiment of the present invention. Due to that the distance between head ends and the CIDC 120 may be large, optical amplifiers (e.g., 901a, 910b, 910c, 910d, . . . , 910e) may be deployed to compensate the loss during the fiber-optic transport. The optical amplifiers may be of any form that is sufficient for the data format. For example, an Erbium doped fiber amplifier (EDFA) or an optical amplifier using Raman or Brillouin scattering may be used. The amplifiers may be lumped at locations along the transmission line, or may be distributed over portions or substantially all of the transmission line.

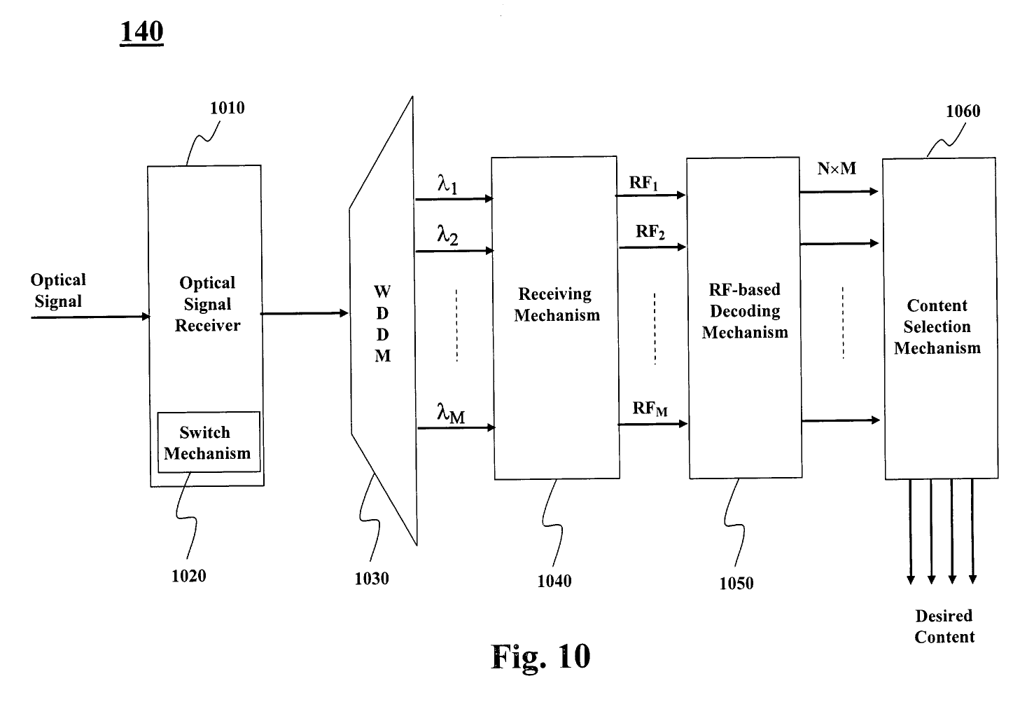

FIG. 10 depicts an exemplary block diagram of a head end (e.g., 140), according to embodiments of the present invention. With the above-described various content distribution frameworks (100, 200, 300, and 400), a head end in any of such configurations is equipped to be capable of receiving an optical signal, that encodes content data of multiple channels, via an optical fiber, decoding the optical signal, and selecting the content desired. The head end 140 comprises, but is not limited to, an optical signal receiver 1010, a wavelength division demultiplexer (WDDM) 1030, a receiving mechanism 1040, an RF-based decoding mechanism 1050, and a content selection mechanism 1060.

The optical signal receiver 1010 is responsible for receiving an optical signal from an optical fiber. When the head end is connected to more than one CIDCs (an additional one may be provided for fault tolerance), the optical signal receiver 1010 may optionally include a switching mechanism 1020 that switches the optical signal receiver 1010 to one of the CIDCs.

The WDDM 1030 takes the received optical signal and demultiplexes it into M optical signals carried in M different optical channels (with different wavelengths). The receiving mechanism 1040 receives the M optical signals and down-converts each of the optical channels to its corresponding RF signal carried by an RF/microwave carrier of certain frequency. The receiving mechanism 1040 may comprise M individual receivers (not shown), each of which is responsible for converting an optical channel with a particular wavelength to an RF carrier with a certain frequency. The output of the receiving mechanism 1040 constitutes M RF signals.

The RF-based decoding mechanism 1050 decodes the M RF signals and converts them into content data of multiple channels. The processing involved here is a reverse process compared with what is performed by the RF-based encoding mechanism 550. For example, each of the RF signals may be demultiplexed into K modulated signals first and then decoded in a multi-level decoding scheme to recover the original multiple data streams. In the exemplary schemes described so far, the total number of data streams is N×M.

Since the content may be broadcasted to all head ends, the received content by a head end may include content that is not desired by the head end. In this case, the head end may further select, from N×M data streams, the desired content. The content selection mechanism 1060 takes the N×M data streams as input and selects the desired content. The selection may be based on various criteria. For example, it may be based on some identification scheme. For instance, each head end may be assigned a unique identification. Content intended to send to a particular head end may be tagged or marked with an identification that matched with the identification of the intended head end.

Content selection may also be made according to the nature of the content. For instance, different types of content may be tagged with different labels. When a head end receives the content, it may select desired content based on the content label. For instance, if a head end is responsible for deliver cable TV content of certain sources (e.g., PBS or CNN), it may select content that is tagged as from those sources.

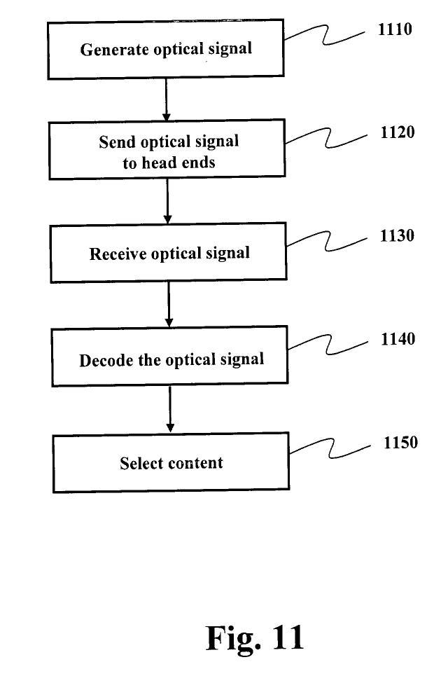

FIG. 11 is a flowchart of an exemplary process, in which a consolidated information content delivery framework (e.g., 100, 200, 300, and 400) sends an optical signal carrying content data of multiple channels to a plurality of head ends via one or more optical fibers, according to embodiments of the present invention. An optical signal is first generated at 1110. When a second CIDC (e.g., 210) is deployed, two optical signals may be individually generated at each CIDC based on the same content.

The generated optical signal is sent, at 1120, to a plurality of head ends via an optical fiber. In the framework 300 with a star configuration, the optical signal may be sent to the head ends via more than one optical fibers. In the framework 400 with a ring configuration, the optical signal may be sent to the head ends via an optical fiber in different (opposite) directions. When a second CIDC (e.g., 210) is used for fault tolerance, both CIDCs (e.g., 120 and 210) may synchronously send optical signals individually generated by each to the head ends.

When each head end receives, at 1130, the optical signal sent from a CIDC (each head end may receive one optical signal, from either of the CIDCs when two CIDCs are deployed) and transported by an optical fiber, it decodes, at 1140, the optical signal to recover the content data. The head end then selects, at 1150, desired content from the decoded content.

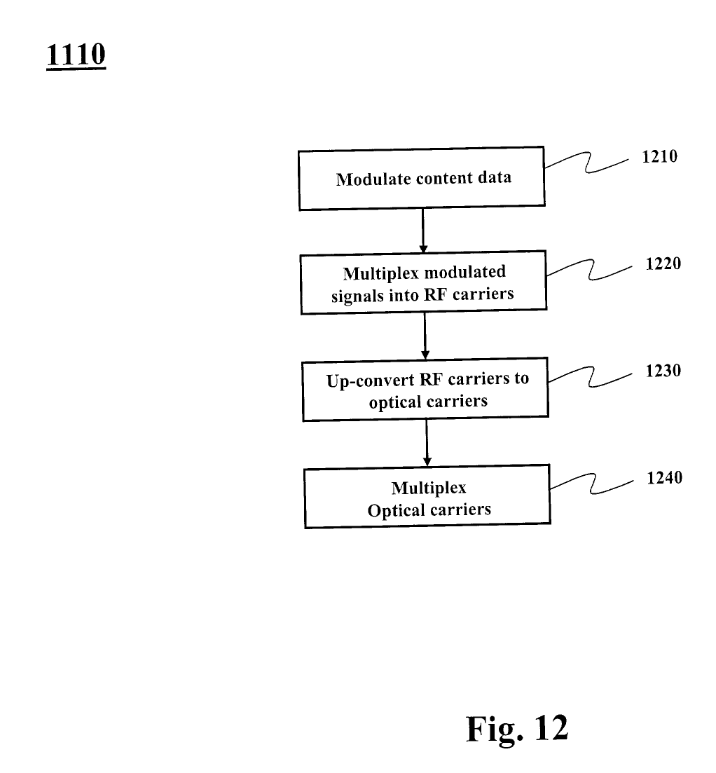

FIG. 12 is a flowchart of an exemplary process, in which a consolidated information distribution center (e.g., the CIDC 120) encodes content data of multiple channels to generate a single optical signal, according to embodiments of the present invention. Multiple data streams of the content is first modulated at 1210 to produce modulated signals. The modulated signals are then multiplexed, at 1220, into one or more RF signals carried by RF carriers. The RF signals carried by the RF carriers are up-converted, at 1230, onto one or more optical channels, which are them multiplexed, at act 1240, into a single optical signal.

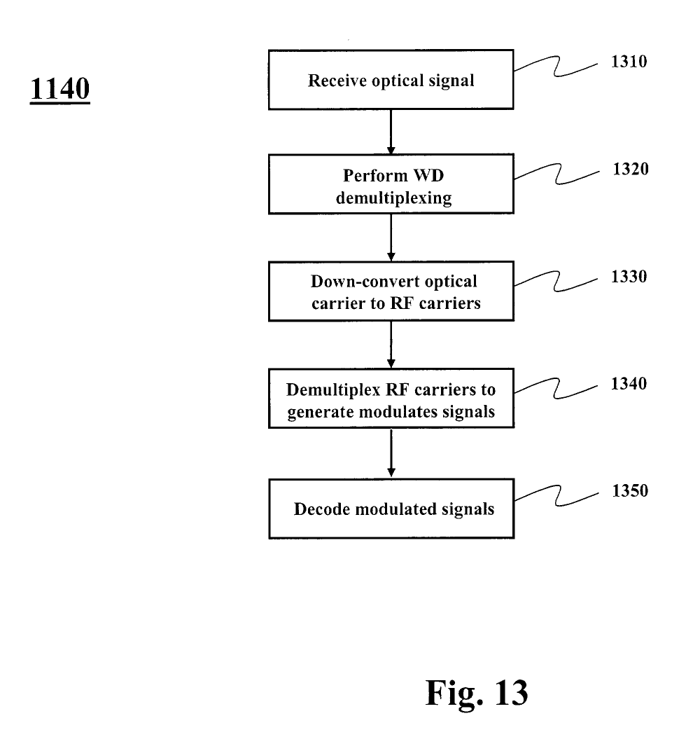

FIG. 13 is a flowchart of an exemplary process, in which a head end decodes an optical signal, received from a consolidated information distribution center via an optical fiber, to generate content data of multiple channels, according to embodiments of the present invention. The optical signal is first received at 1310. Wavelength division demultiplexing is performed, at 1320, to decompose the optical signal into a plurality of optical channels of different wavelengths. Such optical signals are then down-converted, at 1330, to produce a plurality of RF signals. Each of the RF signals is further demultiplexed, at 1340, to produce one or more modulated signals. Finally, the modulated signals are demodulated or decoded, at 1350, to recover the original content.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

We claim:

1. A consolidated information distribution system, comprising:
at least one head end capable of receiving an optical signal;
a consolidated information distribution center, connecting to the at least one head end via at least one optical fiber, capable of sending an optical signal to the at least one head end through the at least one optical fiber that transports the optical signal from the consolidated information distribution center to the at least one head end.

2. The consolidated information distribution system according to claim 1, wherein the at least one head end and the consolidated information distribution center is arranged in a linear configuration in which the at least one head end is arranged in a serial fashion and the optical signal is transported from the consolidated information distribution center to the at least one head end in a direction from a first head end to a last head end.

3. The consolidated information distribution system according to claim 2, further comprising a second consolidated information distribution center connecting to the at least one head end arranged in the serial fashion via the at least one optical fiber, wherein the optical signal is transported from the second consolidated information distribution center to the at least one head end in a direction from the last head end to the first head end.

4. The consolidated information distribution system according to claim 1, wherein the at least one head end and the consolidated information distribution center is arranged in a star configuration in which the optical signal from the consolidated information distribution center is transported via the at least one optical fiber directly to every head end of the at least one head end.

5. The consolidated information distribution system according to claim 4, further comprising a second consolidated information distribution center connecting to the at least one head end in the star configuration via at least one optical fiber, wherein the optical signal from the second consolidated information distribution center is transported directly to every head end of the at least one head end.

6. The consolidated information distribution system according to claim 1, wherein the at least one head end and the consolidated information distribution center is arranged in a ring configuration in which the at least one head end is aranged in a circular fashion, wherein the optical signal from the consolidated information distribution center is transported to the at least one head end in both a first direction from a first head end to a last head end and a second direction from the last head end to the first head end.

7. The consolidated information distribution system according to claim 1, wherein the consolidated information distribution center comprises at least one of:
a satellite farm capable of receiving content data from a satellite; and
a video server capable of providing digital content data.

8. The consolidated information distribution system according to claim 7, wherein the content data comprises a plurality of data channels.

9. The consolidated information distribution system according to claim 8, further comprising an optical signal generation mechanism capable of generating an optical signal based on the content data.

10. The consolidated information distribution system according to claim 9, wherein the optical signal generation mechanism includes:
a radio frequency (RF) based encoding mechanism, capable of modulating the content data of multiple channels into one or more RF/microwave carriers to produce corresponding one or more RF signals;
at least one optical modulator capable of up-converting the RF/microwave carriers onto one or more optical carriers of different wavelengths; and
a wavelength division multiplexer capable of combining the optical carriers of different wavelengths produced by the at least one optical modulator to produce the optical signal.

11. The consolidated information distribution system according to claim 10, wherein each RF based encoding mechanism comprises:
a multi-level encoder capable of modulating content data of at least one channel to produce at least one modulated signal; and
a frequency division mulplexer capable of multiplexing the modulated signals generated by the multi-level encoder onto an RF/microwave carrier to produce a single RF signal.

12. The consolidated information distribution system according to claim 11, wherein the multiple encoder implements one of:
a quadrature amplitude modulation (QAM) encoding scheme; and
a duo-binary encoding scheme.

13. The consolidated information distribution system according to claim 11, wherein each frequency division multiplexer implements a sub-carrier multiplexing scheme.

14. The consolidated information distribution system according to claim 11, wherein the multi-level encoder comprises:
at least one encoder, each of which capable of encoding a data stream to produce an encoded data stream;
at least one combiner, each of which capable of combining a plurality of encoded data streams into a single data stream; and
at least one modulator, each of which capable of converting a single data stream into a modulated signal.

15. The consolidated information distribution system according to claim 3, wherein each head end comprises:
a wavelength division demultiplexer capable of demultiplexing the optical signal, received from the consolidated information distribution center, to produce a plurality of optical channels of different wavelengths;
a receiving mechanism capable of down-converting the plurality of optical channels to produce a plurality of corresponding RF carriers carrying RF signals; and
an RF based decoding mechanism capable of decoding the RF signals to produce multiple data channels.

16. The consolidated information distribution system according to claim 15, further comprising a switching mechanism capable of switching an optical signal receiver to receive the optical signal from one of the consolidated information distribution center and the second consolidated information distribution center via an optical fiber.

17. The consolidated information distribution system according to claim 15, further comprising a content selection mechanism capable of selecting, from the decoded multiple data channels, one or more data channels that are intended to be received by the head end.

18. The consolidated information distribution system according to claim 1, further comprising one or more optical amplifiers distributed along the at least one optical fiber.

19. The consolidated information distribution system according to claim 18, wherein each optical amplifier includes one of:
an Erbium doped fiber amplifier (EDFA); and
an optical amplifier using Raman scattering processes.

20. A consolidated information distribution center capable of sending an optical signal to at least one head end via at least one optical fiber, comprising:
at least one content source providing content data;
an optical signal generation mechanism capable of generating an optical signal based on the content data and sending the optical signal to the at least one head end via the at least one optical fiber.

21. The consolidated information distribution center according to claim 20, wherein the at least one content source includes at least one of:
a satellite farm capable of receiving content data from a satellite; and
a video server capable of providing digital content data.

22. The consolidated information distribution center according to claim 20, wherein the optical signal generation mechanism includes:
a radio frequency (RF) based encoding mechanism, capable of modulating the content data of multiple channels into one or more RF/microwave carriers to produce corresponding one or more RF signals;
at least one optical modulator capable of up-converting the RF/microwave carriers onto one or more optical carriers of different wavelengths; and
a wavelength division multiplexer capable of combining the optical carriers of different wavelengths produced by the at least one optical modulator to produce the optical signal.

23. The consolidated information distribution center according to claim 22, wherein each RF based encoding mechanism comprises:
a multi-level encoders capable of modulating content data of one or more channels to produce one or more modulated signals; and
a frequency division mulplexer capable of multiplexing the modulated signals generated by the multi-level encoders onto an RF/microwave carrier to produce a single RF signal.

24. The consolidated information distribution center according to claim 23, wherein the multiple encoder implements one of:
a quadrature amplitude modulation (QAM) encoding scheme; and
a duo-binary encoding scheme.

25. The consolidated information distribution center according to claim 23, wherein the frequency division multiplexer implements a sub-carrier multiplexing scheme.

26. The consolidated information distribution center according to claim 23, wherein the multi-level encoder comprises:
at least one encoder, each of which capable of encoding a data channel to produce an encoded data stream;
at least one combiner, each of which capable of combining a plurality of encoded data streams into a single data stream; and
at least one modulator, each of which capable of converting a single data stream into a modulated signal.

27. A head end, comprising:
an optical signal receiver capable of receiving an optical signal, transported to at least one head end from a consolidated information distribution center via at least one optical fiber; and
an optical signal decoding mechanism capable of decoding the optical signal to obtain content of multiple channels carried by the optical signal; and
an content selector capable of selecting, from the multiple data channels, one or more desired content channels.

28. The head end according to claim 27, wherein the optical signal decoding mechanism comprises:
a wavelength division demultiplexer capable of demultiplexing the optical signal, received from the consolidated information distribution center, to produce a plurality of optical channels of different wavelengths;
a receiving mechanism capable of down-converting the plurality of optical channels to produce a plurality of corresponding RF carriers carrying RF signals; and
an RF based decoding mechanism capable of decoding the RF signals to produce multiple data channels.

29. The head end according to claim 27, further comprising a switching mechanism capable of switching the optical signal receiver to receive the optical signal from one of the consolidated information distribution center and a second consolidated information distribution center via the optical fiber.

30. A method of distributing information, comprising:
generating, by a consolidated information distribution center, an optical signal based on content data of multiple channels;
sending the optical signal to at least one head end via at least one optical fiber;
receiving, by the at least one head end, the optical signal that is transported through the at least one optical fiber; and
decoding, by the at least one head end, the optical signal to produce the content data of multiple channels.

31. The method according to claim 30, wherein the generating comprises:
modulating the content data of multiple channels to produce one or more modulated signals;
multiplexing the one or more modulated signals onto one or more RF/microwave carriers to produce one or more RF signals, each of which is carried by one of the RF/microwave carriers;
up-converting the one or more RF/microwave carriers carrying the RF signals onto one or more optical carriers of different wavelengths; and
multiplexing the one or more optical carriers to produce the optical signal.

32. The method according to claim 30, wherein the decoding comprises:
demultiplexing the optical signal received via the optical fiber to produce one or more optical carriers;
down-converting the one or more optical carriers to one or more RF/microwave carriers that carry RF signals;
demultiplexing the RF signals to produce modulated signals; and
decoding the modulated signals to produce the content data of multiple channels.

33. The method according to claim 30, further comprising selecting, by each of the at least one head end, one or more desired content channels from the multiple channels.

34. The method according to claim 30, further comprising switching, prior to the receiving, an optical signal receiver located in each of the at least one head end to receive the optical signal from one of the consolidated information distribution center and a second consolidated information distribution center.

35. A method for a consolidated information distribution center, comprising:
generating a single optical signal based on content data of multiple channels; and
sending the optical signal to at least one head end via at least one optical fiber.

36. The method according to claim 35, wherein the generating comprises:
modulating the content data of multiple channels to produce one or more modulated signals;
multiplexing the one or more modulated signals onto one or more RF/microwave carriers to produce one or more RF signals, each of which is carried by one of the RF/microwave carriers;
up-converting the one or more RF/microwave carriers carrying the RF signals onto one or more optical carriers of different wavelengths; and
multiplexing the one or more optical carriers to produce the optical signal.

37. A method for a head end, comprising:
receiving an optical signal transported through at least one optical fiber connecting to the head end; and
decoding the optical signal to produce the content data of multiple channels.

38. The method according to claim 37, wherein the decoding comprises:
demultiplexing the optical signal received via the optical fiber to produce one or more optical carriers;
down-converting the one or more optical carriers to one or more RF/microwave carriers that carry RF signals;
demultiplexing the RF signals to produce modulated signals; and
decoding the modulated signals to produce the content data of multiple channels.

39. The method according to claim 37, further comprising switching, prior to the receiving, an optical signal receiver located in the head end to receive the optical signal from one of a consolidated information distribution center and a second consolidated information distribution center.

40. The method according to claim 37, further comprising selecting, from the multiple channels, one or more desired content channels.

41. An article comprising a storage medium having stored thereon instructions for distributing information that, when executed by a machine, result in the following:
generating, by a consolidated information distribution center, an optical signal based on content data of multiple channels;
sending the optical signal to at least one head end via at least one optical fiber;
receiving, by the at least one head end, the optical signal that is transported through the at least one optical fiber; and
decoding, by the at least one head end, the optical signal to produce the content data of multiple channels.

42. The article according to claim 41, wherein the generating comprises:
modulating the content data of multiple channels to produce one or more modulated signals;
multiplexing the one or more modulated signals onto one or more RF/microwave carriers to produce one or more RF signals, each of which is carried by one of the RF/microwave carriers;
up-converting the one or more RF/microwave carriers carrying the RF signals onto one or more optical carriers of different wavelengths; and
multiplexing the one or more optical carriers to produce the optical signal.

43. The article according to claim 41, wherein the decoding comprises:
demultiplexing the optical signal received via the optical fiber to produce one or more optical carriers;
down-converting the one or more optical carriers to one or more RF/microwave carriers that carry RF signals;
demultiplexing the RF signals to produce modulated signals; and
decoding the modulated signals to produce the content data of multiple channels.

44. The article according to claim 41, the instructions, when executed by a machine, further result in selecting, by each of the at least one head end, one or more desired content channels from the multiple channels.

45. The article according to claim 41, the instructions, when executed by a machine, further result in switching, prior to the receiving, an optical signal receiver located in each of the at least one head end to receive the optical signal from one of the consolidated information distribution center and a second consolidated information distribution center.

46. An article comprising a storage medium having stored thereon instructions for a consolidated information distribution center that, when executed by a machine, result in the following:
generating an optical signal based on content data of multiple channels; and
sending the optical signal to at least one head end via at least one optical fiber.

47. The article according to claim 46, wherein the generating comprises:
modulating the content data of multiple channels to produce one or more modulated signals;
multiplexing the one or more modulated signals onto one or more RF/microwave carriers to produce one or more RF signals, each of which is carried by one of the RF/microwave carriers;
up-converting the one or more RF/microwave carriers carrying the RF signals onto one or more optical carriers of different wavelengths; and
multiplexing the one or more optical carriers to produce the optical signal.

48. An article comprising a storage medium having stored thereon instructions for a head end that, when executed by a machine, result in the following:
receiving an optical signal transported through at least one optical fiber connecting to the head end; and
decoding the optical signal to produce the content data of multiple channels.

49. The article according to claim 48, wherein the decoding comprises:
demultiplexing the optical signal received via the optical fiber to produce one or more optical carriers;
down-converting the one or more optical carriers to one or more RF/microwave carriers that carry RF signals;
demultiplexing the RF signals to produce modulated signals; and
decoding the modulated signals to produce the content data of multiple channels.

50. The article according to claim 48, the instructions, when executed by a machine, further result in switching, prior to the receiving, an optical signal receiver located in the head end to receive the optical signal from one of a consolidated information distribution center and a second consolidated information distribution center.

51. The article according to claim 48, the instructions, when executed by a machine, further result in selecting, from the multiple channels, one or more desired content channels.
